(19) United States
(12) Patent Application Publication
(10) Pub. No.: US 2005/0234746 A1
(43) Pub. Date: Oct. 20, 2005

(54) Medical information provision method, and client terminal and statistical server used for the same

(75) Inventor: Takeshi Funahashi, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/085,216

(22) Filed: Mar. 22, 2005

(30) Foreign Application Priority Data
Mar. 26, 2004 (JP) 2004-090855

(51) Int. Cl. G06F 17/60

(52) U.S. Cl. 705/3

(57) ABSTRACT

A medical information provision method capable of collectively storing examination result data including information on examination results obtained in plural medical institutions, patient attribute information and examination attribute information etc., and providing various kinds of medical information to the respective medical institutions based on the examination result data. The medical information provision method includes the steps of: transmitting, as examination result data, data obtained by an examination and patient attribute information etc. from a client terminal to a database server; storing the examination result data in a first recording medium; extracting predetermined kind of information from the examination result data and storing the extracted information in a second recording medium; and providing medical information to the client terminal by retrieving related information from the information stored in the second recording medium based on an information request signal transmitted from the client terminal.

### BACKGROUND OF THE INVENTION

1. Field of the Invention

The present invention relates to a medical information provision method of providing various kinds of medical information from a data center, which centrally stores examination result data obtained in plural medical institutions, to the respective medical institutions. Furthermore, the present invention relates to a client terminal and a statistical processing server to be used in such a medical information provision method.

2. Description of a Related Art

Conventionally, in medical institutions such as clinics of general practitioners and hospitals, medical images have been taken by using medical image taking apparatuses utilizing radiation (X-ray, α-ray, β-ray, γ-ray, electron beam, ultraviolet light, etc.), ultrasonic waves, MR (magnetic resonance) and so on. Such medical images are required to be stored in order to know changes in medical conditions of patients, and required to be stored in a predetermined period by law. Accordingly, in the medical institutions, it is necessary to store a vast amount of medical images. Conventionally, films or the like, on which medical images are taken, have been stored, and thereby, securing of storage space, management work, and retrieval work of medical images have imposed heavy burdens on the medical institutions.

On the other hand, in recent years, digitization of medical image taking apparatuses has been proceeding, and by recording medical images as image data in optical disks, magnetic disks or the like, storage space can be reduced and management work and retrieval work can be saved. However, since one sheet of medical image is represented by a vast amount of image data, even if medical images are recorded in optical disks, a considerable number of optical disks are required to store medical data for a predetermined period.

Further, electronization is progressing in patient attribute information such as a name of patient and an ID number, examination attribute information concerning medical benefit (medical practice defined in the medical fee table), medical service fee point, and creation of medical fee receipt for recording total points. Furthermore, in recent years, medical institutions have increased that introduce electronic clinical charts, in which clinical charts for recording medical service information on patients are generated by using electronic components, and diagnosis results when diagnosis is performed by interpretation of medical images have been recorded in the electronic clinical charts.

As a related technology, Japanese Patent Application Publication JP-A-2002-24394 discloses a medical image collective management system by which medical data can be stored and managed by simple work with drastically reduced space for storing medical image data in medical institutions and without requiring a considerable expense. In this medical image collective management system, image data, which is formed by converting medical images taken in medical institutions into digital signals, and so on are recorded and accumulated in a hard disk provided in a client terminal. The client terminal makes connection to a medical database server provided in a provider via a communication line and transmits and receives image data and so on and retrieves image data stored in the medical database server subject to verification of password.

Further, Japanese Patent Application Publication JP-A-2003-186997 discloses an integrated electronic clinical chart system by which medical service records, which concerns medical services provided in the medical institutions, are stored in the respective medical institutions, and contents of the medical services recorded in the medical service records can be referred to from other medical institutions. In this integrated electronic clinical chart system, medical consultation information representing consultation history as to when and which patient consults and patient IDs assigned for identification of the patients within the medical institution are transmitted from the electronic clinical chart systems of the respective medical institutions via Internet to an electronic clinical chart server.

### SUMMARY OF THE INVENTION

The present invention has been achieved in view of the above-described points. One object of the present invention is to provide a medical information provision method capable of collectively storing examination result data including information on examination results obtained in plural medical institutions, patient attribute information and examination attribute information etc., and providing various kinds of medical information to the respective medical institutions based on the examination result data. Another object of the present invention is to provide a client terminal and a statistical processing server to be used in such a medical information provision method.

In order to achieve the above-described objects, a medical information provision method according to the present invention is used in a system formed by connecting a plurality of terminals provided in a medical institution and a plurality of servers provided in a data center via a network, and includes the steps of: (a) collecting at least information on a patient and information on an examination in a client terminal provided in the medical institution from another terminal provided in the medical institution; (b) transmitting, as examination result data, data obtained by an examination intended for diagnosis in the medical institution and information collected at step (a) from the client terminal to a first server provided in the data center; (c) storing the examination result data received by the first server in a first recording medium; (d) extracting predetermined kind of information from the examination result data stored in the first recording medium and storing the extracted information in a second recording medium under control of a second server provided in the data center; (e) transmitting an information request signal for requesting provision of desired medical information from the client terminal to the second server; (f) retrieving related information from the information stored in the second recording medium based on the information request signal received by the second server; (g) performing statistical processing on the information retrieved at step (f); and (h) generating medical information based on the information statistically processed at step (g) and providing the medical information from the second server directly or indirectly to the client terminal.

Further, a client terminal according to the present invention is provided in a medical institution and to be connected to a plurality of servers provided in a data center via a network, and includes: information collecting means for collecting at least information on a patient and information on an examination from another terminal provided in the medical institution; transmission control means for transmitting, as examination result data, data obtained by an examination intended for diagnosis in the medical institution and information collected by the information collecting means to a first server provided in the data center; information requesting means for transmitting an information request signal for requesting provision of desired medical information to a second server provided in the data center according to operation by an operator; and display means for displaying medical information generated based on the examination result data by the second server which responds to the information request signal.

Furthermore, a statistical processing server according to the present invention is provided in a data center with a database server and to be connected to a client terminal provided in a medical institution via a network, and includes: information extracting means for extracting predetermined kind of information from examination result data stored in a first recording medium by the database server, which receives, as examination result data, data obtained by an examination intended for diagnosis in the medical institution and at least information on a patient and information on an examination, and storing the extracted information in a second recording medium; retrieval control means for retrieving related information from the information stored in the second recording medium based on an information request signal for requesting provision of desired medical information transmitted from the client terminal; statistical processing means for performing statistical processing on the information retrieved by the retrieval control means; and transmission control means for generating medical information based on the information statistically processed by the statistical processing means and providing the medical information directly or indirectly to the client terminal.

According to the present invention, various kinds of medical information can be provided to the respective medical institutions by collecting information on patients, information on examinations and so on in the client terminal and performing statistical processing on these kinds of information in the statistical processing server.

### BRIEF DESCRIPTION OF THE DRAWINGS

FIG. 1 is a schematic diagram showing a configuration of a medical information provision system including a client terminal and a statistical processing server according to one embodiment of the present invention;

FIG. 2 is a block diagram showing the configuration including a radiation imaging apparatus to be used in the one embodiment of the present invention;

FIG. 3 is a block diagram showing the constitution of the client terminal according to the one embodiment of the present invention;

FIG. 4 is a block diagram showing the constitution of the statistical processing server according to the one embodiment of the present invention;

FIG. 5 is a flowchart (the first half) showing the operation of the medical information provision system when registering retrieval result data in the one embodiment of the present invention;

FIG. 6 is a flowchart (the second half) showing the operation of the medical information provision system when registering the retrieval result data in the one embodiment of the present invention; and

FIG. 7 is a flowchart showing the operation of the medical information provision system when providing medical information in the one embodiment of the present invention.

### DESCRIPTION OF THE PREFERRED EMBODIMENTS

Hereinafter, an embodiment of the present invention will be described in detail by referring to the drawings. The same reference numerals are assigned to the same component elements and the description thereof will be omitted.

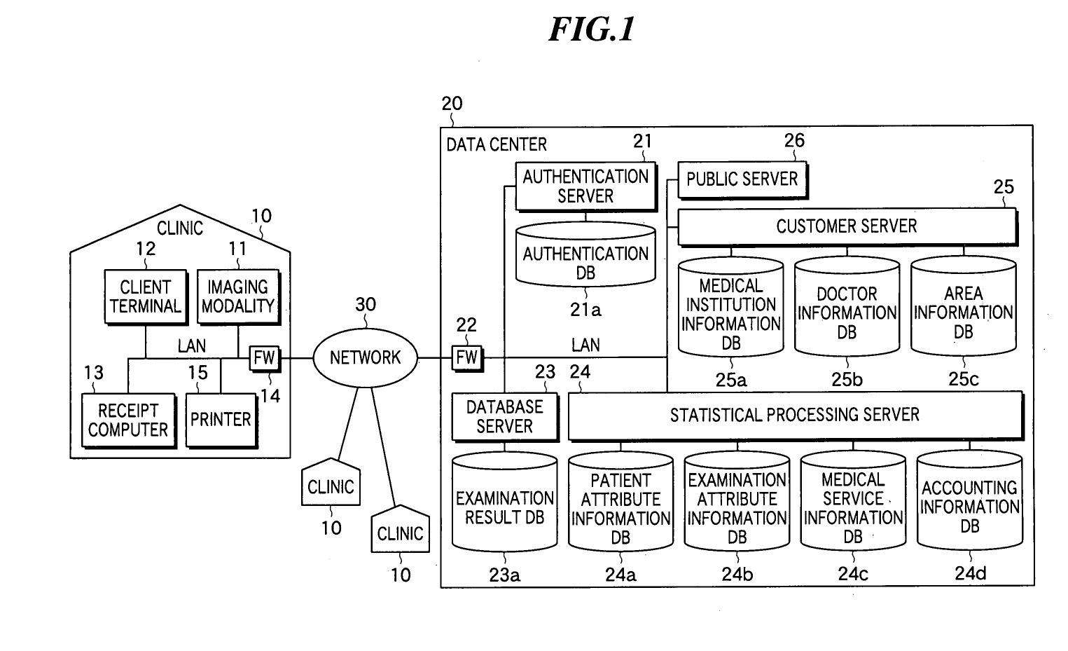

FIG. 1 is a schematic diagram showing a configuration of a medical information provision system including a client terminal and a statistical processing server according to one embodiment of the present invention. As shown in FIG. 1, this medical information provision system includes plural clinics 10 as examples of medical institutions connected via a network 30 such as a dedicated line, a public switched telephone network (PSTN), the Internet or the like to a data center 20.

In each clinic 10, an imaging modality 11 such as a radiation imaging apparatus or an ultrasonic diagnostic apparatus, a client terminal 12 for receiving information on examination results such as image data representing medical images from the imaging modality 11 and transferring the information to the data center 20, a receipt computer 13 for creating receipts based on patient attribute information, examination attribute information, etc. and recording them, a firewall (FW) 14 for preventing unauthorized access, a printer 15 for printing out medical images on films or the like are connected via a local area network (LAN) to each others. In the embodiment, the client terminal 12 collects patient attribute information, examination attribute information, medical service information and accounting information from the receipt data recorded in the receipt computer 13, and transmits, as examination result data, those kinds of information with information on examination results to the data center 20.

In the data center 20, an authentication server 21 for authenticating access from client terminals 12, a recording medium such as a hard disk in which an authentication database (DB) 21a for accumulating user information required for authentication is recorded, a firewall (FW) 22 for preventing unauthorized access, a database server 23 for receiving and managing the examination result data transmitted from the client terminals 12, and a recording medium such as a hard disk in which an examination result database (DB) 23a for accumulating the examination result data is recorded are provided. In the embodiment, the authentication server 21 is provided within the data center 20, however, the authentication server 21 may be provided outside of the data center 20.

Further, in the data center 20, there are provided a statistical processing server 24 for extracting the patient attribute information, examination attribute information, medical service information and accounting information from the examination result data accumulated in the examination result database (DB) 23a and performing statistical processing based on those kinds of information etc., a recording medium such as a hard disk in which a patient attribute information database (DB) 24a for accumulating patient attribute information is recorded, a recording medium such as a hard disk in which an examination attribute information database (DB) 24b for accumulating examination attribute information is recorded, a recording medium such as a hard disk in which a medical service information database (DB) 24c for accumulating medical service information is accumulated, and a recording medium such as a hard disk in which an accounting information database (DB) 24d for accumulating accounting information is recorded.

The patient attribute information includes information representing name of patient, ID number of patient, date of birth, age, sex, Basic Resident Registers number, family structure, previous history, with or without and kinds of allergies, address, etc., for example. Here, the family structure corresponds to persons that form a family, age and medical service history of each person.

The examination attribute information includes information representing date of examination, day of the week of examination, date of consultation, part to be examined, examination device, examination method, etc., for example. Here, the part to be examined corresponds to cephalic part, cervical part, thoracic part, thoracoabdominal part, abdominal part, lumber spine, four limbs, etc. as targets of examination. Further, the examination method corresponds to with or without contrast agent and so on. Furthermore, in the case of a medical institution to which plural doctors belong, the examination attribute information may include information representing a doctor in charge.

The medical service information includes information representing name of disease and injury, treatment period, kind and amount of medication, name of prescription pharmacy, means for taking appointment, number of visiting patients, etc., for example. Here, the treatment period is a period in which the patient sees a doctor regularly at the medical institution because of the same name of disease and injury, and the means for taking appointment refers to which means of home phone, mobile phone or facsimile is used for taking the appointment, or without appointment.

Further, the accounting information includes information representing consultation fee, medication fee, examination fee, with or without coverage by insurance, etc., for example.

Furthermore, in the data center 20, a customer server 25 for managing medical institution information, doctor information, area information, etc., a recording medium such as a hard disk in which a medical institution information database (DB) 25a for accumulating medical institution information is recorded, a recording medium such as a hard disk in which a doctor information database (DB) 25b for accumulating doctor information is recorded, a recording medium such as a hard disk in which an area information database (DB) 25c for accumulating area information is recorded, and a public server 26 for providing results of statistical processing performed by the statistical processing server 24 to the client terminal 12 as medical information are provided.

The medical institution information includes information representing location, specialty, year of establishment, medical institution serial number, possession and number of examination devices, affiliated hospital, affiliated clinic, etc., for example. Here, the affiliated hospital refers to a hospital affiliated in consultation services by requesting examinations, introducing patients and so on. Further, the affiliated clinic refers to a clinic affiliated in consultation services by requesting examinations, introducing patients and so on.

The doctor information includes information representing name of doctor, specialty, graduating school, hospital working record, year of acquisition of medical license (consultation history), medical institution serial number where the doctor belongs, etc., for example. Here, the hospital working record refers to the names of hospital, clinical department and a number of years the doctor has worked for.

The area information includes information representing location and a number of neighboring education institutions, a number of children by age, name and number of medical institutions by specialty, etc., for example. Here, the location of neighboring education institutions refers to location of primary schools, junior high schools, high schools and universities in the neighborhood of each medical institution, and the number of neighboring education institutions refers to respective numbers of primary schools, junior high schools, high schools and universities in the neighborhood of each medical institution. Further, the number of medical institutions by specialty refers to a number of medical institutions with respect to each specialty.

In the embodiment, the database server 23 receives examination result data transmitted from the client terminals 12 and accumulates the received examination result data in the examination result database 23a. Further, the statistical processing server 24 extracts the patient attribute information, examination attribute information, medical service information and accounting information from the examination result data accumulated in the examination result database 23a and accumulates those kinds of information in the databases 24a to 24d, respectively. Furthermore, the statistical processing server 24 performs statistical processing on the information accumulated in the databases 24a to 24d to generate medical information. The public server 26 discloses the medical information generated by the statistical processing server 24 to the client terminals 12, such that the medical information can be utilized for promotion of efficiency of medical services in medical institutions.

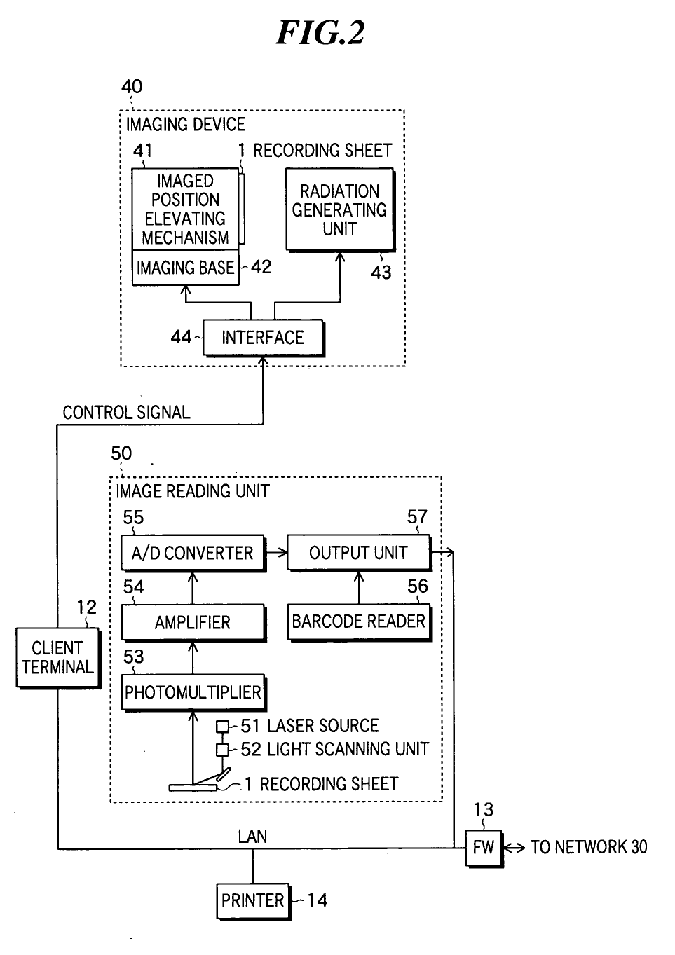

Next, as an example of obtaining data by the examination intended for diagnosis in the medical institution, the case of using a radiation imaging apparatus as the imaging modality 11 to generate image data will be described by referring to FIG. 2. The radiation imaging apparatus as shown in FIG. 2 includes an imaging device 40 for performing imaging by applying radiation on an examinee to record a radiation image on a recording sheet 1, and an image reading device 50 for photoelectrically reading information such as the radiation image recorded on the recording sheet 1 to generate image data and image accompanying information associated with the radiation image. The recording sheet 1 is coated with a photostimulable phosphor material and information on a subject is recorded thereon by applying radiation thereto. The photostimulable phosphor material (accumulative phosphor) is a material in which, when applied with radiation, part of radiation energy is accumulated, and then, when applied with excitation light such as visible light, photostimulably emits light according to the accumulated energy.

The imaging device 40 includes an imaged position elevating mechanism 41 for elevating an imaged position in the examinee by finely adjusting the position of the recording sheet 1 to move upward or downward, an imaging base 42 for positioning the feet of the examinee, a radiation generating unit 43 for applying radiation to the examinee, and an interface 44 to which control signals are inputted from the client terminals 12.

The image reading device 50 scans the surface of the recording sheet 1 set in a predetermined position with a light beam outputted from the laser source 51 passing through the light scanning unit 52. By the scanning, the light beam is applied to the recording sheet 1, and photostimulably emitted light is generated from the location applied with the light beam and in an amount of light depending on the radiation image information that has been accumulatively recorded. The photostimulably emitted light is photoelectrically detected by a photomultiplier 53, and the detected signal is outputted as an analog signal, amplified by an amplifier 54, and digitized by an A/D converter 55. Further, a barcode attached to a cassette, in which the recording sheet 1 is stored, is read by a barcode reader 56, and the read barcode information is used as image accompanying information corresponding to the patient information and the examination information. Thus generated image data and image accompanying information are transmitted from an output unit 57 via the LAN to the client terminals 12.

The client terminal 12 controls the imaging device 40, and receives the image data and image accompanying information from the image reading device 50 and temporarily stores them. In the client terminal 12, image processing can be performed on the image data, and images for diagnosis can be displayed based on the image data and image accompanying information on a display or the like. However, since a vast amounts of image data are daily accumulated, they are stored not for a long period in the clinic 10, but transferred to the data center 20 apart from the clinic 10 and stored there as shown in FIG. 1. Thereby, in the clinic 10, space for storing recording media in which medical data have been recorded or costs for securing the space can be reduced.

Further, in the embodiment, the client terminal 12 collects patient attribute information, examination attribute information, medical service information and accounting information on the examination performed in the clinic 10 from the receipt data recorded in the receipt computer 13 and transmits the information to the data center 20 such that various kinds of medical information obtained by performing statistical processing or the like on those kinds of information in the data center 20 can be utilized by the client terminal 12.

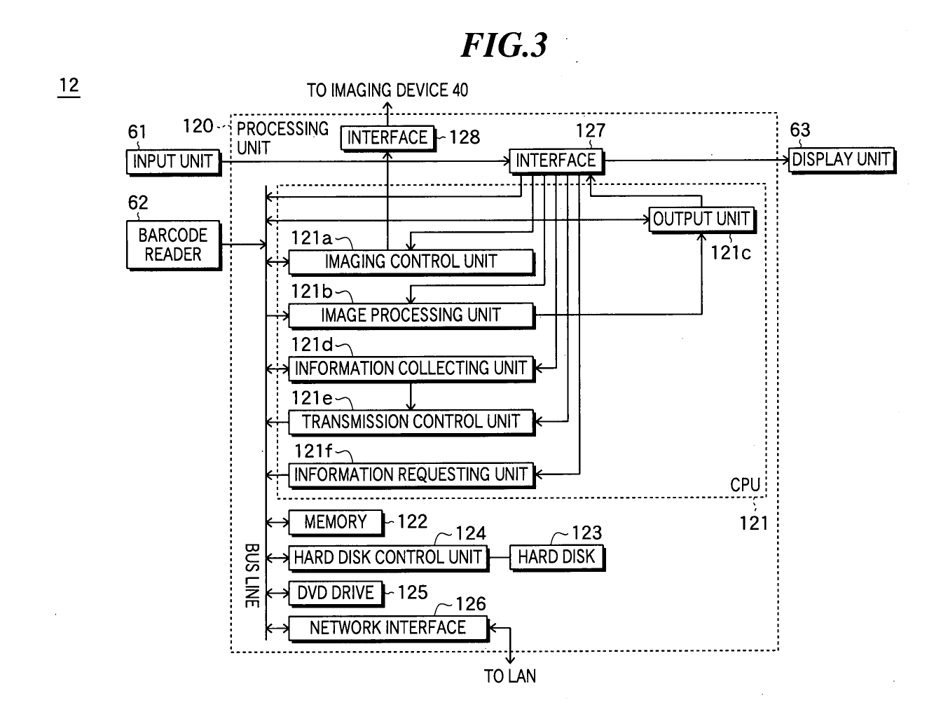

FIG. 3 is a block diagram showing the constitution of the client terminal according to the one embodiment of the present invention. The client terminal 12 includes an input unit 61 to be used for inputting various kinds of instructions, a barcode reader 62 for reading a barcode attached to a cassette in which the recording sheet 1 is stored, a display unit 63 for displaying images for diagnosis and so on, and a processing unit 120. The medical images read by the image reading device 50 (FIG. 2) are correlated with the patient attribute information and the examination attribute information stored in the client terminal 12 based on the barcode information read from the cassette by using the barcode reader 62 in advance before imaging. As to the patient attribute information and the examination attribute information to be used as image accompanying information, only the minimum information for identifying the patient and the examination respectively is sufficient.

The processing unit 120 includes a central processing unit (hereinafter, referred to as CPU) 121, a memory 122 for temporarily storing inputted image data and patient attribute information, examination attribute information, medical service information and accounting information, a hard disk 123 as a recording medium, a hard disk control unit 124 for controlling the hard disk 123, a DVD drive 125 for performing writing and reading on a DVD (digital versatile disk), and a network interface 126 for connection to a LAN. These parts 121 to 126 are connected to each others via a bus line.

Further, the processing unit 120 includes interfaces 127 and 128. The CPU 121 is connected to the input unit 61 such as a keyboard or mouse and the display unit 63 such as a CRT display via the interface 127, and connected to the imaging device 40 via the interface 128.

In the hard disk 123, software (control program) for activating the CPU 121 to perform operation is recorded. As the recording medium for recording the control program, not only the built-in hard disk 123, but also an external hard disk, a flexible disk, an MO, an MT, a RAM, a CD-ROM, a DVD-ROM, or the like may be used.

Next, function blocks 121a to 121f formed by the CPU 121 and software (control program) will be described.

The imaging control unit 121a controls via the interface 128 the imaging device 40 to start an examination based on the patient attribute information and the examination attribute information stored in the memory 122.

The image processing unit 121b performs necessary image processing on the image data received from the image reading device 50, and generate display data for displaying medical images on the display unit 63. Further, the image processing unit 121b generates display data for displaying medical information on the display unit 63 based on the various kinds of medical information received from the data center 20. The display data is supplied from the output unit 121c via the interface 127 to the display unit 63, medical images or medical information are displayed on the display unit 63, and those are confirmed by the operator. Further, the image data that has been subjected to the necessary image processing is stored in the memory 122 and recorded in the hard disk 123 under the control of the hard disk control unit 124 according to the set conditions.

The information collecting unit 121d collects the patient attribute information, examination attribute information, medical service information and accounting information from the receipt data recorded in the receipt computer 13 according to the instructions of the operator by using the input unit 61 or the set conditions.

When the examination result data is thus obtained, in order to store the examination result data in the data center 20 as shown in FIG. 1, the transmission control unit 121e starts to access the data center 20 according to the instructions inputted by the operator using the input unit 61 or set conditions. In the data center 20, in order to prevent leaks of personal information, falsification of medical image data and so on, an authentication is requested to access to the database server 23, and access to the database server 23 is inhibited until it is allowed by the authentication.

When the transmission control unit 121e makes inquiries about access right to the authentication server 21 of the data center 20 and the access right is authenticated in the authentication server 21, the transmission control unit 121e transmits the examination result data stored in storage means such as the memory 122 or hard disk 123 and allows recording of the information in the examination result database 23a.

The information requesting unit 121f starts to access to the data center 20 in response to the instruction for downloading the medical information inputted by the operator using the input unit 61. In the same way as described as to the transmission control unit 121e, the information requesting unit 121f transmits an information request signal to the data center 20 so that the public server 26 may disclose the medical information. Here, the information request signal includes (i) information for identifying the transmission source of the information request signal such as a medical institution serial number and (ii) retrieval keyword such as a name of disease and injury inputted by using the input unit 61.

In the embodiment, the information collecting unit 121d collects the patient attribute information, examination attribute information, medical service information and accounting information from the receipt data, however, in the case where the receipt computer 13 or another terminal creates an electronic clinical chart, the information collecting unit 121d may collect the patient attribute information, examination attribute information, medical service information and accounting information from the electronic clinical chart.

By the way, in the embodiment, the imaging control unit 121a, the image processing unit 121b, the output unit 121c, the information collecting unit 121d, the transmission control unit 121e and the information requesting unit 121f are formed by a CPU and software, however, they may be formed by a digital circuit or an analog circuit.

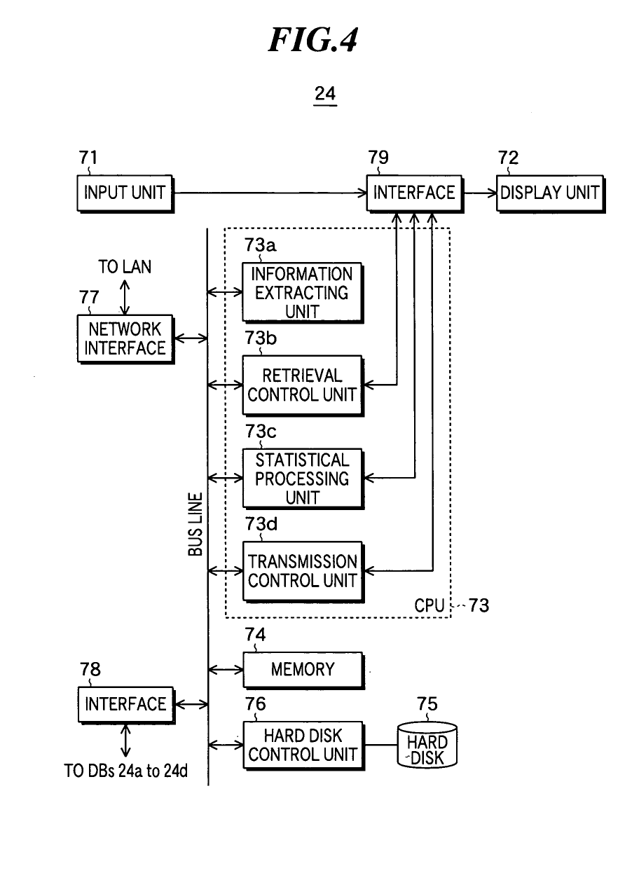

FIG. 4 is a block diagram showing the constitution of a statistical processing server according to one embodiment of the present invention. The statistical processing server 24 includes an input unit 71 to be used for inputting various kinds of instructions, a display unit 72 for display for management of patient attribute information, examination attribute information, medical service information and accounting information, a central processing unit (hereinafter, referred to as CPU) 73, a memory 74 for temporarily storing the examination result data read from the examination result database 23a, a hard disk 75 as a recording medium, a hard disk control unit 76 for controlling the hard disk 75, a network interface 77 for connection to a LIAN, and an interface 78 for controlling the databases (DBs) 24a to 24d. These parts 71 to 78 are connected to each others via a bus line.

Further, the statistical processing server 24 includes the interface 79. The CPU 73 is connected to the input unit 71 such as a keyboard or mouse and the display unit 72 such as a CRT display via the interface 79.

In the hard disk 75, software (control program) for activating the CPU 73 to perform operation is recorded. As the recording medium for recording the control program, not only the built-in hard disk 75, but also an external hard disk, a flexible disk, an MO, an MT, a RAM, a CD-ROM, a DVD-ROM, or the like may be used.

Next, function blocks 73a to 73d formed by the CPU 73 and software (control program) will be described.

The information extracting unit 73a reads out the examination result data recorded in the examination result database 23a, extracts the patient attribute information, examination attribute information, medical service information and accounting information from the examination result data, and accumulate those kinds of information in the databases 24a to 24d, respectively.

On the basis of a retrieval keyword included in the information request signal transmitted from the client terminal 12 and information for identifying the transmission source such as a medical institution serial number, the retrieval control unit 73b retrieves desired information, which is related to the retrieval keyword and/or the transmission source, from the databases 24a to 24d and databases 25a to 25d.

The statistical processing unit 73c generates various kinds of medical information by performing statistical processing on the retrieved information. The transmission control unit 73d directly transmits the generated various kinds of medical information to the client terminal 12 or transmits the information to the public server 26. The public server 26 processes the various kinds of medical information received from the statistical processing server 24 and transmits the processed medical information to the client terminal 12.

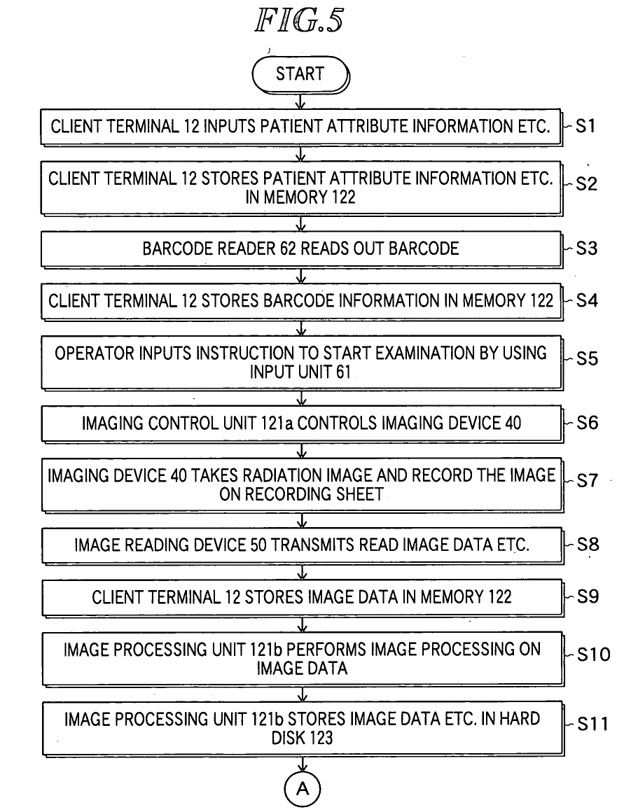

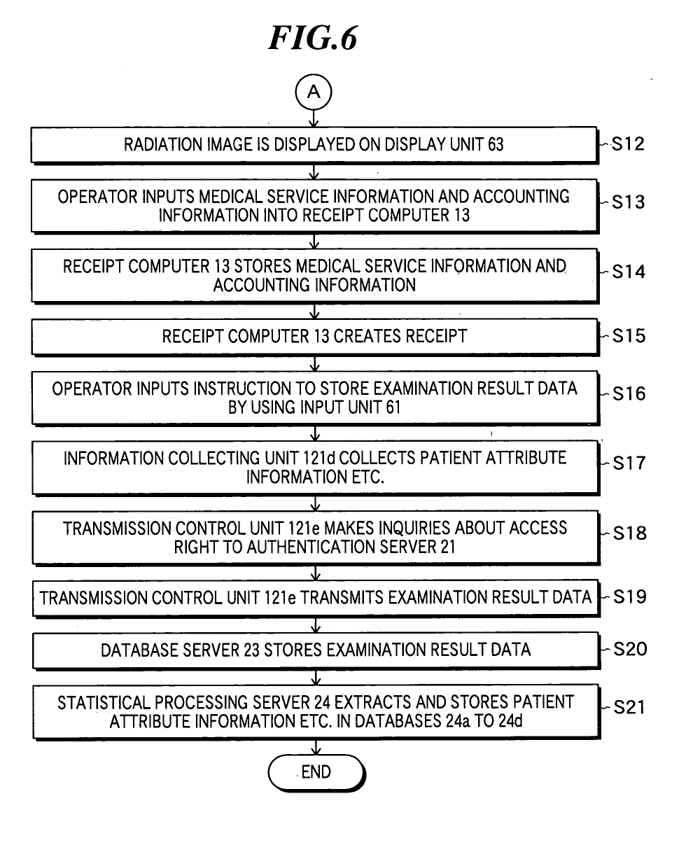

Next, the operation of the medical information provision system when registering the retrieval result data will be described by referring to FIGS. 1 to 6. FIGS. 5 and 6 are flowcharts showing the operation of the medical information provision system when registering the retrieval result data in the embodiment.

At step S1 in FIG. 5, the client terminal 12 receives patient attribute information and examination attribute information transmitted from the receipt computer 13 or another terminal. Alternatively, patient attribute information and examination attribute information may be inputted into the client terminal 12 according to operation by the operator. Then, at step S2, the client terminal 12 stores the received patient attribute information and the examination attribute information in the memory 122.

At step S3, the operator uses the barcode reader 62 to read out the barcode attached to the cassette in which the recording sheet 1 is stored. At step S4, the client terminal 12 stores the barcode information, which has been generated by reading out the barcode, in association with the patient information and the examination information in the memory 122.

At step S5, the operator inputs an instruction to start an examination by using the input unit 61 of the client terminal 12. At step S6, the imaging control unit 121a controls the imaging device 40 based on the patient attribute information and the examination attribute information in response to the instruction to start the examination. At step S7, the imaging device 40 takes a radiation image by applying radiation to an examinee based on the patient attribute information and the examination attribute information under the control of the imaging control unit 121a and records the radiation image onto the recording sheet.

At step S8, the image reading device 50 generates image data by reading the radiation image recorded on the recording sheet 1 and transmits the generated image data with the barcode information to the client terminal 12.

At step S9, the client terminal 12 stores the image data and the barcode information received from the image reading device 50 in the memory 122. Here, the client terminal 12 matches the barcode information received from the image reading device 50 with the barcode information generated by the barcode reader 62 so as to associate the image data with the patient attribute information and the examination attribute information, and stores the patient attribute information and the examination attribute information as image accompanying information in the memory 122.

At step S10, the image processing unit 121b performs image processing on the image data stored in the memory 122. At step S11, the image processing unit 121b stores the image data representing the medical images and image accompanying information associated with the medical images in storage means such as the hard disk 123.

At step S12 in FIG. 6, radiation images are displayed on the display unit 63 of the client terminal 12 based on the image data that has been subjected to image processing. At step S13, the operator inputs into the receipt computer 13 the medical service information such as a name of disease and injury, kinds and amounts of medication and accounting information such as a medical fee and medication fee based on the consultation results obtained from the consultation by the doctor while interpreting the radiation images being displayed on the display unit 63. At step S14, the receipt computer 13 stores the inputted medical service information and accounting information.

At step S15, the receipt computer 13 creates a receipt based on the patient attribute information, examination attribute information, medical service information and accounting information, and records receipt data representing the receipt.

At step S16, the operator inputs an instruction to store the examination result data by using the input unit 61. At step S17, the information collecting unit 121d collects the patient attribute information, examination attribute information, medical service information and accounting information from the receipt data recorded in the receipt computer 13 in response to the instruction to store the examination result data.

At step S18, the transmission control unit 121e makes inquiries about access right to the authentication server 21 of the data center 20. When the access right is authenticated by the authentication server 21, then at step S19, the transmission control unit 121e transmits examination result data with information for identifying the clinic 10 such as the medical institution serial number to the database server 23 of the data center 20. The examination result data includes (i) data obtained by an examination intended for diagnosis such as the radiation image data and (ii) the patient attribute information, examination attribute information, medical service information and accounting information collected by the information collecting unit 121d.

Then, at step S20, the database server 23 accumulates the received examination result data in association with the information for identifying the transmission source such as a medical institution serial number in the examination result database 23a. Thereby, the examination result data is stored in the data center 20.

At step S21, the information extracting unit 73a of the statistical processing server 24 extracts the patient attribute information, examination attribute information, medical service information and accounting information from the examination result data recorded in the examination result database 23a, and stores those kinds of information in association with the information for identifying the transmission source such as medical institution serial numbers in the databases 24a to 24d, respectively.

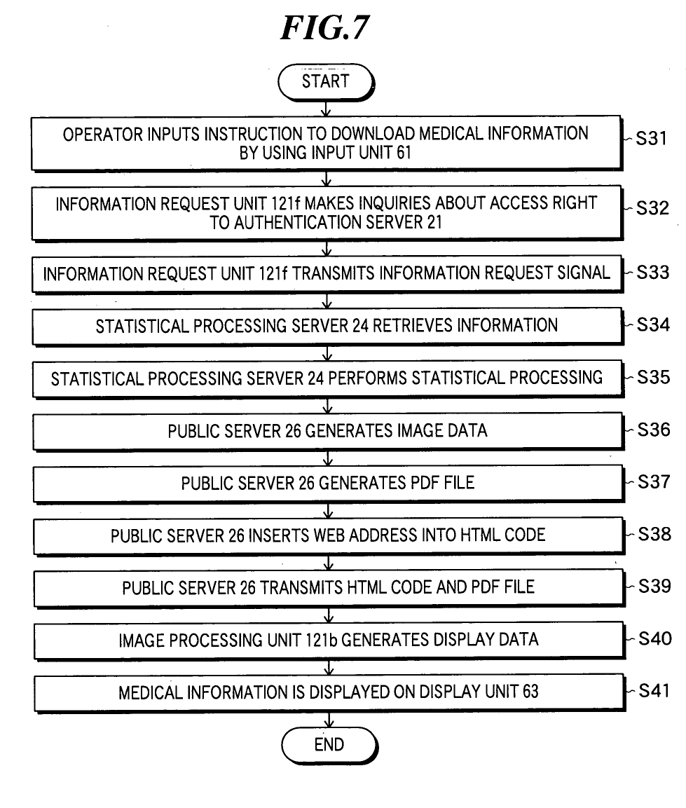

Next, the operation of the medical information provision system including the terminal and the server according to the embodiment when providing medical information will be described by referring to FIGS. 1 to 4 and 7. FIG. 7 is a flowchart showing the operation of the medical information provision system when providing medical information in the embodiment.

As shown in FIG. 7, at step S31, the operator inputs an instruction to download medical information and a retrieval keyword by using the input unit 61 of the client terminal 20. Then, at step S32, the information requesting unit 121f makes inquiries about access right to the authentication server 21 of the data center 20 in response to the instruction to download medical information.

When the access right is authenticated in the authentication server 21, then at step S33, the information requesting unit 121f transmits an information request signal from the client terminal 12 to the statistical processing server 24 of the data center 20 for provision of medical information. The information request signal includes information for identifying the transmission source of the information request signal such as a medical institution serial number with the retrieval keyword.

Note that the steps S31 to S33 are performed independently from the steps S16 to S19 as shown in FIG. 6. When the steps S31 to S33 are performed subsequently to the steps S16 to S19, since the access right has been already authenticated, the step S32 may be omitted.

Then, at step S34, the statistical processing server 24 retrieves desired information from the databases 24a to 24d and databases 25a to 25d based on the retrieval keyword and information for identifying the transmission source such as a medical institution serial number included in the received information request signal. Further, the statistical processing server 24 may retrieve the location of the medical institution information and retrieve information about the neighborhood of the clinic from the area information database 25c based on the location.

At step S35, the statistical processing server 24 performs statistical processing on the retrieved information and generates various kinds of medical information in the XML (extensible markup language) format as a general-purpose data format.

For example, the statistical processing server 24 retrieves at step S34 the age and address included in the patient attribute information, the examination date included in the examination attribute information, and the location and number of the neighboring educational institutions included in the area information, and generates at step S35 medical information representing geographical distribution of patients by statistically calculating the increase of patients in the educational institutions based on these retrieval results. By displaying geographical distribution of the increase of patients in the educational institutions in a graph, the doctor can analogize the future distribution expectation.

Alternatively, the statistical processing server 24 retrieves at step S34 the kind of medication included in the medical service information and the medication fee and examination fee included in the accounting information, and calculates at step S35 the kinds of medicine and examination in heavy usage and the cost thereof to generate medical information representing the list of them based on these retrieval results. Displaying such medical information helps the doctor to find a low-cost medicine with the same effect, for example, generic product.

Alternatively, the statistical processing server 24 retrieves at step S34 the location of the clinic included in the medical institution information, the name of doctor, graduating university and hospital working record included in the doctor information and the institution name of medical institutions by specialty included in the area information, and generates at step S35 medical information representing the list of information about doctors having the same background or clinics based on these retrieval results.

Furthermore, the statistical processing server 24 may generate at step S35 medical information in which information is classified based on the institution name of the medical institutions by specialty, or calculate the distance from the own hospital based on the location included in the medical institution information and the location of the medical institutions by specialty included in the area information so as to generate the medical information including the information representing the distance from the own hospital. Displaying such medical information helps the doctor to introduce a patient to another hospital.

Alternatively, the statistical processing server 24 may retrieve at step S34 the ages included in the patient attribute information, and the examination dates, examination days of the week, parts to be examined, examination devices, and examination methods included in the examination attribute information, and calculates at step 35 examination distribution of patients on each day of the week so as to generate medical information representing the examination distribution of patients on each day of the week based on these retrieval results. Displaying such medical information helps the doctor to determine most appropriate day of the week and data when employing laboratory technicians.

By the way, the output form such as a graph or table and the kind of generated medical information such as a statistical content may be designated by using the input unit 61 of the client terminal 12, or may be registered in the medical information database 25a in advance.

At step S36, the public server 26 generates image data representing a graph or table based on the medical information in the XML format generated at step S35. Then, at step S37, the public server 26 generates a PDF (portable document format) file by converting the image data generated at step S36 into PDF form.

Furthermore, at step S38, the public server 26 inserts a web address or the like in a HTML (hypertext markup language) code so that the PDF file generated at step S37 may be expanded in a web page via a web browser. At step S39, the public server 26 transmits the HTML code and the PDF file as medical information to the client terminal 12.

At step S40, the image processing unit 121b of the client server 12 generates display data for displaying the medical information as a web page based on the received HTML code and PDF file. At step S41, the medical information is displayed as a web page on the display unit 63 of the client terminal 12 based on the display data generated at step S40.

In the embodiment, after the information request signal is received, the statistical processing server 24 starts retrieval and statistical processing and the public server 26 generates the HTML code and PDF file, however, the statistical processing server 24 may perform retrieval and statistical processing at pre-designated time intervals, or the statistical processing server 24 may perform retrieval and statistical processing when new examination result data is not received in a predetermined period.

1. A medical information provision method to be used in a system formed by connecting a plurality of terminals provided in a medical institution and a plurality of servers provided in a data center via a network, said method comprising the steps of:
(a) collecting at least information on a patient and information on an examination in a client terminal provided in said medical institution from another terminal provided in said medical institution;
(b) transmitting, as examination result data, data obtained by an examination intended for diagnosis in said medical institution and information collected at step (a) from said client terminal to a first server provided in said data center;
(c) storing the examination result data received by said first server in a first recording medium;
(d) extracting predetermined kind of information from the examination result data stored in said first recording medium and storing the extracted information in a second recording medium under control of a second server provided in said data center;
(e) transmitting an information request signal for requesting provision of desired medical information from said client terminal to said second server;
(f) retrieving related information from the information stored in said second recording medium based on the information request signal received by said second server;
(g) performing statistical processing on the information retrieved at step (f); and
(h) generating medical information based on the information statistically processed at step (g) and providing the medical information from said second server directly or indirectly to said client terminal.

2. The medical information provision method according to claim 1, wherein step (a) includes collecting patient attribute information, examination attribute information, medical service information and accounting information in the client terminal provided in said medical institution from the other terminal provided in said medical institution.

3. The medical information provision method according to claim 1, wherein step (f) includes retrieving related information from the information stored in said second recording medium and a third recording medium for storing information on medical institutions as customers based on the information request signal received by said second server.

4. The medical information provision method according to claim 1, wherein step (h) includes generating medical information based on the information statistically processed at step (g), transmitting the medical information from said second server to a third server provided in said data center, processing the received medical information in said third server, and providing the processed medical information from said third server to said client terminal.

5. A client terminal provided in a medical institution and to be connected to a plurality of servers provided in a data center via a network, said client terminal comprising:
information collecting means for collecting at least information on a patient and information on an examination from another terminal provided in said medical institution;
transmission control means for transmitting, as examination result data, data obtained by an examination intended for diagnosis in said medical institution and information collected by said information collecting means to a first server provided in said data center;
information requesting means for transmitting an information request signal for requesting provision of desired medical information to a second server provided in said data center according to operation by an operator; and
display means for displaying medical information generated based on the examination result data by said second server which responds to the information request signal.

6. The client terminal according to claim 5, wherein said information collecting means collects patient attribute information, examination attribute information medical service information and accounting information from the other terminal provided in said medical institution.

7. A statistical processing server provided in a data center with a database server and to be connected to a client terminal provided in a medical institution via a network, said statistical processing server comprising:
information extracting means for extracting predetermined kind of information from examination result data stored in a first recording medium by said data base server, which receives, as examination result data, data obtained by an examination intended for diagnosis in said medical institution and at least information on a patient and information on an examination, and storing the extracted information in a second recording medium;
retrieval control means for retrieving related information from the information stored in said second recording medium based on an information request signal for requesting provision of desired medical information transmitted from said client terminal;
statistical processing means for performing statistical processing on the information retrieved by said retrieval control means; and
transmission control means for generating medical information based on the information statistically processed by said statistical processing means and providing the medical information directly or indirectly to said client terminal.

8. The statistical processing server according to claim 7, wherein said retrieval control means retrieves related information from the information stored in said second recording medium and a third recording medium for storing information on medical institutions as customers based on the information request signal transmitted from said client terminal.

9. The statistical processing server according to claim 7, wherein said transmission control means generates medical information based on the information statistically processed by said statistical processing means and transmits the medical information to a third server provided in said data center such that said third server can process the received medical information and provide the processed medical information to said client terminal.
